(19) United States
(12) Patent Application Publication
(10) Pub. No.: US 2009/0252536 A1
(43) Pub. Date: Oct. 8, 2009

(54) PRINTING APPARATUS

(75) Inventors: Chung-Kai Wang, Taipei (TW); Chien-Kuo Kuan, Taipei (TW)

Correspondence Address: KIRTON AND MCCONKIE, 60 EAST SOUTH TEMPLE,, SUITE 1800, SALT LAKE CITY, UT, 84111, US

(73) Assignee: PRIMAX ELECTRONICS LTD., Taipei (TW)

(21) Appl. No.: 12/246,160

(22) Filed: Oct. 6, 2008

(30) Foreign Application Priority Data
Apr. 2, 2008 (TW) 097111927

(51) Int. Cl. G03G 15/04

(52) U.S. Cl. 399/220

(57) ABSTRACT

The present invention relates to a printing apparatus. The printing apparatus includes a plurality of rollers, a micro light source set, an optical photoconductive drum, an imaging lens assembly, and a print unit. The micro light source set includes multiple micro light sources arranged in a row for producing multiple respective light beams. The imaging lens assembly is disposed between the micro light source set and the optical photoconductive drum for allowing the multiple light beams to pass through so as to image on the optical photoconductive drum.

### FIELD OF THE INVENTION

The present invention relates to a printing apparatus, and more particularly to a printing apparatus with micro light sources.

### BACKGROUND OF THE INVENTION

Printing apparatuses are essential information apparatuses in modern offices. A typical printing apparatus principally comprises a paper input tray, a paper ejecting tray, a plurality of rollers, a print region, an optical scanning module and a print unit. The print unit principally comprises a charging roller, a developer roller, a toner adding roller, a transferring roller, a blade and a fusing unit. For printing a document by the printing apparatus, the document is firstly placed in the printing apparatus. Next, the image of the document is read and transmitted to the optical scanning module. Next, the charging roller uniformly charges the outer surface of the optical photoconductive drum of the optical scanning module. After the charging procedure, the optical scanning module linearly scans the image in a form of laser beams, thereby forming an electrostatic latent image of the document on the optical photoconductive drum. This procedure is also referred as an exposing procedure. After the exposing procedure, the toner adding roller supplies the developer roller with toner from a toner cartridge. Next, the developer roller contacts with the optical photoconductive drum for supplying the electrostatic latent image on the optical photoconductive drum with toner. As a consequence, the electrostatic latent image formed on the optical photoconductive drum is rendered visible as a toner image. After the above image processing procedure in the print unit is completed, a blank paper placed on the paper input tray is transported by a paper pick-up roller into the print region. In the print region, the paper is attracted onto the surface of the optical photoconductive drum and contacted with the toner. Since the transferring roller on the rear side of the paper and the toner are oppositely charged, the toner on the optical photoconductive drum will be adsorbed onto the paper. After the toner image is transferred to the paper, the blade will remove the toner remaining on the optical photoconductive drum for reuse. Afterwards, the toner image is fixed onto the paper by the fusing unit and thus the printing operation is completed.

Hereinafter, the exposing procedure of the optical scanning module will be illustrated in more details with reference to FIG. 1.

FIG. 1 is a schematic view illustrating an optical scanning module of a conventional printing apparatus. The optical scanning module 100 of FIG. 1 principally comprises a light source 101, a first optical lens 102, a second optical lens 103, a polygonal mirror 104, a third optical lens 105, a reflective mirror 106 and an optical photoconductive drum 107. The first optical lens 102 is disposed downstream of the light source 101 to collimate the light beams from the light source 101 into parallel beams. By the second optical lens 103, the parallel beams are subject to a unidirectional focusing operation such that the parallel beams are focused as elliptical beams. The elliptical beams are reflected by the polygonal mirror 104. Uniform rotation of the polygon mirror 104 results in multi-angular reflective beams. The reflective beams are focused by the third optical lens 105, reflected by the reflective mirror 106, and projected on the optical photoconductive drum 107. As known, the arrangement of the third optical lens 105 must achieve f-θ correction to adjust the position shift and the light speed. The light source 101 commonly used in the optical scanning module 100 is for example a laser diode or a light emitting diode. The a first optical lens 102, the second optical lens 103, and the third optical lens 105 are also referred as collimator lens, cylinder lens and f-θ scan lens, respectively. In these optical elements, the third optical lens 105 is decisive for the scanning quality. In other words, the precision of the third optical lens 105 may influence the scanning quality of the printing apparatus. For example, the light beams should be converged on the optical photoconductive drum 107 by the third optical lens 105. Moreover, the f-θ correction of the third optical lens 105 must ensure scan linearity, which is relatively important. Moreover, for obtaining a good scanning quality, the third optical lens 105 must have the ability to correct the curve of field, color aberrations, polygonal mirror dynamic tilting, and the like.

Hereinafter, the operations of the optical scanning module will be illustrated. For printing a document by the printing apparatus, the document is firstly placed in the printing apparatus. When the printing operation is activated, the optical scanning module 100 is enabled and thus the light source 101 is triggered to emit light beams. The light beams from the light source 101 are collimated into parallel beams by the first optical lens 102. The parallel beams are focused as elliptical beams by the second optical lens 103 and the elliptical beams are projected onto the polygon mirror 104. By rotating the polygon mirror 104, the elliptical beams are reflected by the polygonal mirror 104 at different angles. The reflective beams are corrected by the third optical lens 105, reflected by the reflective mirror 106, and projected on the optical photoconductive drum 107. After the image of the document is fully scanned, the electrostatic latent image of the document is distributed on the optical photoconductive drum 107. Meanwhile, the exposing procedure of the optical scanning module is finished.

Moreover, the correlation between the polygon mirror 104 and the third optical lens 105 is also important in designing the optical scanning module. In other words, many factors including the incidence angle of the light beams, the scanning length, the light beam profiles, the depth of field, the scan linearity, the color aberrations, the polygonal mirror dynamic tilting should be taken into consideration. Since high precision is required to assemble the conventional printing apparatus, the allowable tolerance is very small. Due to the small allowable tolerance, the printing performance of the printing apparatus is readily deteriorated if any tiny deviation of the above factors occurs. Under this circumstance, the printing apparatus needs to be frequently adjusted or maintained, so that the use of such a printing apparatus is not user-friendly.

### SUMMARY OF THE INVENTION

An object of the present invention provides a printing apparatus with a relatively larger allowable tolerance.

It is another object of the present invention to provide a printing apparatus having a reduced volume.

It is a further object of the present invention to provide a printing apparatus having a simplified structure.

In accordance with an aspect of the present invention, there is provided a printing apparatus for printing an image of a document on a paper. The printing apparatus includes a plurality of rollers, a micro light source set, an optical photoconductive drum, an imaging lens assembly, and a print unit. The rollers are used for transporting the paper. The micro light source set includes multiple micro light sources arranged in a row for producing multiple respective light beams. The optical photoconductive drum is used for receiving the multiple light beams, wherein the length of the optical photoconductive drum is equal to the width of the document. The imaging lens assembly is disposed between the micro light source set and the optical photoconductive drum for allowing the multiple light beams to pass through such that the image of the document is imaged on the optical photoconductive drum. The print unit is used for printing the image of the document on the paper.

In an embodiment, the print unit includes a charging roller, a developer roller, a transferring roller, a toner adding roller, a blade and a fusing unit.

In an embodiment, the micro light sources include electroluminescence (EL) light sources or organic light emitting diodes (OLEDs).

In an embodiment, the document is A4-sized and the optical photoconductive drum has a length of 216 mm.

In an embodiment, the document is A3-sized and the optical photoconductive drum has a length of 297 mm.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating an optical scanning module of a conventional printing apparatus;

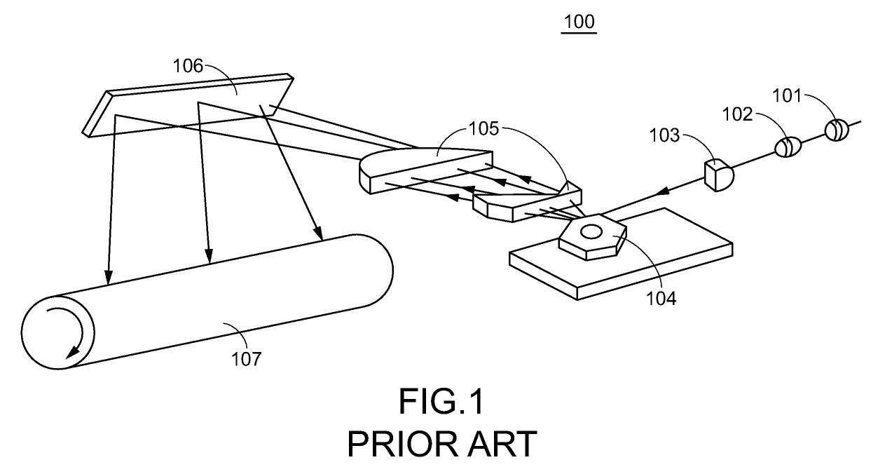

FIG. 2 is a schematic cross-sectional view illustrating a printing apparatus according to a preferred embodiment of the present invention; and

FIG. 3 is a schematic view illustrating an exemplary optical scanning module used in the printing apparatus of the present invention.

### DETAILED DESCRIPTION OF THE PREFERRED EMBODIMENT

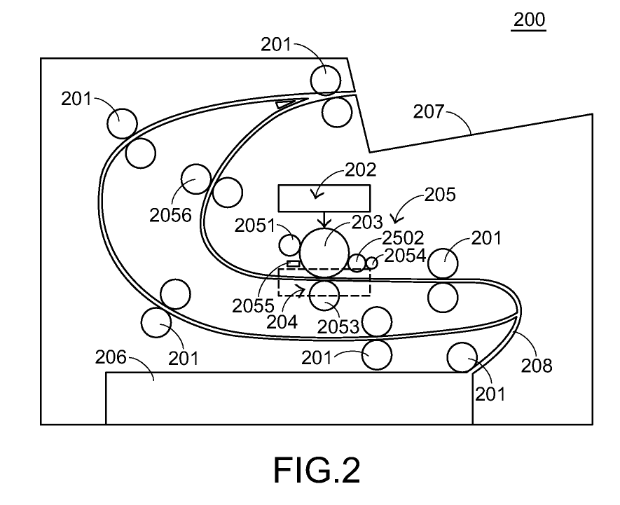

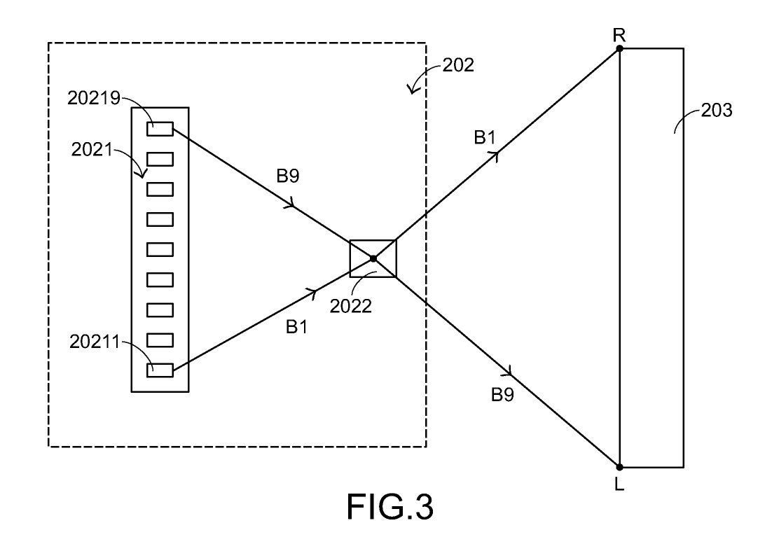

FIG. 2 is a schematic cross-sectional view illustrating a printing apparatus according to a preferred embodiment of the present invention. The printing apparatus 200 of FIG. 2 principally comprises a plurality of rollers 201, an optical scanning module 202, an optical photoconductive drum 203, a print region 204, a print unit 205, a paper input tray 206, a paper ejecting tray 207 and a channel 208. The optical scanning module 202 comprises a plurality of micro light sources 2021 and an imaging lens assembly 2022, as will be described in FIG. 3. The print unit 205 comprises a charging roller 2051, a developer roller 2052, a transferring roller 2053, a toner adding roller 2054, a blade 2055and a fusing unit 2056. The rollers 201 are disposed inside the printing apparatus 200 for transporting papers through the channel 208. The optical scanning module 202 and the optical photoconductive drum 203 are responsible for developing the image of the document. By the print unit 205, the images of the documents can be printed on the papers.

FIG. 3 is a schematic view illustrating an exemplary optical scanning module 202 used in the printing apparatus 200 of the present invention. The optical scanning module 202 comprises a micro light source set 2021 and an imaging lens assembly 2022. The micro light source set 2021 includes multiple (e.g. nine) micro light sources arranged in a row. The imaging lens assembly 2022 is composed of several imaging lenses. Examples of the micro light sources include electroluminescence (EL) light sources or organic light emitting diodes (OLEDs). The micro light source set 2021 can produce multiple light beams. These light beams are imaged on the optical photoconductive drum 203 by the imaging lens assembly 2022. The distances between the micro light sources of the micro light source set 2021 and the imaging lens assembly 2022 and the distance between the imaging lens assembly 2022 and the optical photoconductive drum 203 are dependent on the refractive indexes of the imaging lenses and the lens layout of the imaging lens assembly 2022.

Please refer to FIG. 2 and FIG. 3. For printing a document by the printing apparatus 200, the document is firstly placed in the printing apparatus 200. When the printing operation is activated, the optical scanning module 202 is enabled and thus the micro light sources of the micro light source set 2021 are triggered to emit corresponding light beams. As shown in FIG. 3, the first micro light source 20211 of the micro light source set 2021 can emit a first light beam B1, and the ninth micro light source 20211 of the micro light source set 2021 can emit a ninth light beam B9. Next, the charging roller 2051 of the print unit 205 uniformly charges the outer surface of the optical photoconductive drum 203. After the charges are fully distributed on the optical photoconductive drum 203, the first micro light source 20211 of the optical scanning module 202 emits the first light beam B1. According to the optical imaging principle, the first light beam B1 is converged on an end R of the optical photoconductive drum 203 by the imaging lens assembly 2022. Similarly, the ninth micro light source 20211 of the micro light source set 2021 emits the ninth light beam B9, which is converged on the other end L of the optical photoconductive drum 203 by the imaging lens assembly 2022. After the above exposing procedure, an electrostatic latent image is formed on the optical photoconductive drum 203. Next, the toner adding roller 2054 supplies the developer roller with toner from the toner cartridge 2052. Next, the developer roller 2052 contacts with the optical photoconductive drum for supplying the electrostatic latent image on the optical photoconductive drum 203 with toner. As a consequence, the electrostatic latent image formed on the optical photoconductive drum 203 is rendered visible as a toner image. After the above image processing procedure is completed, a blank paper placed on the paper input tray 201 is transported in the channel 208 by a roller 201 into the print region 204. In the print region 204, the paper is attracted onto the surface of the optical photoconductive drum 203 and contacted with the toner. Since the transferring roller 2053 and the toner are oppositely charged, the toner on the optical photoconductive drum 203 will be adsorbed onto the paper. The paper is continuously transported in the channel 208. After the toner image is transferred to the paper, the blade 2055 will remove the toner remaining on the optical photoconductive drum 203 for reuse. Next, the paper is heated and pressed by the fusing unit 2056 so as to fix the toner image onto the paper. Afterwards, the paper is transported to the paper ejecting tray 207 and thus the printing operation is completed.

In the above embodiments, the printing apparatus of the present invention uses the imaging lens assembly between the micro light source set and the optical photoconductive drum to replace the many optical elements (e.g. the multiple lenses, the polygonal mirror and the like) used in the conventional printing apparatus. Accordingly, the printing apparatus of the present invention has a simplified structure and a reduced volume. Moreover, since the multiple lenses and the polygonal mirror are omitted according to the present invention, the printing apparatus of the present invention can have a relatively larger allowable tolerance.

Furthermore, the arrangement of the imaging lens assembly can facilitate reducing the length of the micro light source set. In the conventional printing apparatus, the lengths of the micro light source set and the optical photoconductive drum are determined according to the size of the document to be printed. For example, if an A4-sized document is intended to be printed, the length of the optical photoconductive drum should be at least equal to the width of the A4-sized document (i.e. 216 mm) and the length of the micro light source set should also be at least equal to the width of the A4-sized document. On the other hand, if an A3-sized document is intended to be printed, the length of the optical photoconductive drum should be at least equal to the width of the A3-sized document (i.e. 297 mm). In the printing apparatus of the present invention, the focusing lenses and the polygonal mirror in the conventional printing apparatus are replaced by the imaging lens (i.e. a convex lens). According to the optical imaging principle, the magnification of the image is dependent on the distance from the object to the lens (i.e. the objective distance). For example, if the object is positioned between twice the focal length (2f) and the focal length (f) of the imaging lens, the image is larger than the object. That is, the micro light source set can be deemed as the real object and the distance from the micro light source set to the imaging lens is the objective distance. By properly adjusting the distance from the micro light source set to the imaging lens, the image on the optical photoconductive drum can be greater than the length of the micro light source set. In other words, an A4-sized image is obtained even if the length of the micro light source set is smaller than the A4 size (i.e. 216 mm).

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A printing apparatus for printing an image of a document on a paper, said printing apparatus comprising:
a plurality of rollers for transporting said paper;
a micro light source set comprising multiple micro light sources arranged in a row for producing multiple respective light beams;
an optical photoconductive drum for receiving said multiple light beams, wherein the length of said optical photoconductive drum is equal to the width of said document;
an imaging lens assembly disposed between said micro light source set and said optical photoconductive drum for allowing said multiple light beams to pass through such that said image of said document is imaged on said optical photoconductive drum; and
a print unit for printing said image of said document on said paper.

2. The printing apparatus according to claim 1 wherein said print unit includes a charging roller, a developer roller, a transferring roller, a toner adding roller, a blade and a fusing unit.

3. The printing apparatus according to claim 1 wherein said micro light sources include electroluminescence (EL) light sources or organic light emitting diodes (OLEDs).

4. The printing apparatus according to claim 1 wherein said document is A4-sized and said optical photoconductive drum has a length of 216 mm.

5. The printing apparatus according to claim 1 wherein said document is A3-sized and said optical photoconductive drum has a length of 297 mm.
